(19) United States
(12) Patent Application Publication
(10) Pub. No.: US 2015/0346752 A1
(43) Pub. Date: Dec. 3, 2015

(54) COMBINATION POWER SOURCE FOR INSTRUMENTED SENSOR SUBSYSTEMS

(71) Applicant: SHELL OIL COMPANY, Houston, TX (US)

(72) Inventor: Bruce Harrison STORM, Houston, TX (US)

(73) Assignee: SHELL OIL COMPANY, Houston, TX (US)

(21) Appl. No.: 14/653,606

(22) PCT Filed: Dec. 19, 2013
(86) PCT No.: PCT/US13/76381

§ 371 Date: Jun. 18, 2015

Related U.S. Application Data
(60) Provisional application No. 61/740,649, filed on Dec. 21, 2012.

(51) Int. Cl. G05F 1/66; G05B 15/02

(52) U.S. Cl. CPC G05F 1/66; G05B 15/02

(57) ABSTRACT

An instrumented sensor subsystem power supply for use in hydrocarbon drilling operations. The system includes an external internal power supply, wired to an external conductive coil. In addition, an instrumented sensor subsystem is installed on an oilfield component adapted for use in a wellbore. The instrumented sensor subsystem includes an internal inductive coil and an internal power storage unit, and creates a magnetic flux region between the internal and external conductive coils when both are in close proximity. The instrumented sensor subsystem also includes a measurement sensor electrically connected to the internal power storage unit and conductive coil.

### STATEMENT OF FIELD

The invention relates to supplying power to instrumented sensor subsystems (“ISS”), an assembly typically used in hydrocarbon drilling operations. In particular, the invention relates to powering, charging, or signaling an ISS using multiple independent batteries.

### BACKGROUND

In drilling or casing operations, an instrumented sensor subsystem (“ISS”) is typically mounted onto equipment, such as a drill string, to measure parameters in real time. These parameters include tension, torque, RPM, position, acceleration, and temperature. The ISS is separate from the drilling or casing apparatus and requires electrical power to operate. An ISS may also contain data storage and data transmission functions to facilitate the collection and use of information collected. These functions require transmission of an electrical signal into the ISS.

One way to power an ISS is the use of an internal power storage unit “power supply” such as an internal power storage unit or capacitor. Although batteries and capacitors are common and stable pieces of equipment, power available from internal power storage units will decrease with use, limiting the operability of an ISS. In addition, the risk of sudden signal loss requires a user to monitor the ISS consistently.

A second method for powering an ISS is inductive coupling, a technique analogous to transformer technology and known in the art. In this approach, the ISS contains an inductive coil comprised of multiple turns of a conductive wire, and an additional inductive coil (also comprised of multiple turns of a conductive wire) located outside the ISS is aligned with the internal coil. The passage of current through the external inductive coil induces an electric current in the coil located within the ISS, generating power. This approach provides a constant power source to the ISS as long as the coils are aligned, but the alignment is sensitive to the distance between the coils and foreign materials that may come between the coils. Inductive coupling is thus susceptible to noise and interruption.

### SUMMARY

In accordance with preferred embodiments, there is provided a combination ISS power supply that includes both an internal power storage unit power supply and an inductive coil. Combining an internal power storage unit with an inductive coil provides advantages not available when either source is used alone.

A particular advantage to using an internal power storage unit in combination with an inductive coil is the ability to use current from the inductive coil to charge the internal power supply. This provides a non-invasive method for recharging the ISS's internal power supply, eliminating the need to remove and replace the ISS internal power storage unit after use. The inductive coil may power the ISS simultaneously or alternatively from the internal power storage unit power supply in operation.

The combination of an inductive coil and internal power storage unit offers additional advantages. Providing an internal power storage unit mitigates the risk of noise and interruption present when an ISS contains only a conductive coil. The inductive coil offers a complementary advantage by providing a source of power that lasts throughout the operation implementing the ISS.

In addition, the combination power source may permit more variability in ISS design, such as allowing a smaller outer diameter or total volume than would be possible in alternative models. The induced field may be used to transmit signal as well as power to or from the ISS.

### BRIEF DESCRIPTION OF THE DRAWINGS

For a more detailed understanding of the invention, reference is made to the accompanying drawings wherein:

FIG. 1 is a schematic illustration of an ISS containing an embodiment of the invention and a corresponding external power source.

FIG. 2 is a diagram of an ISS containing an embodiment of the invention in relation to other components.

### DETAILED DESCRIPTION OF A PREFERRED EMBODIMENT

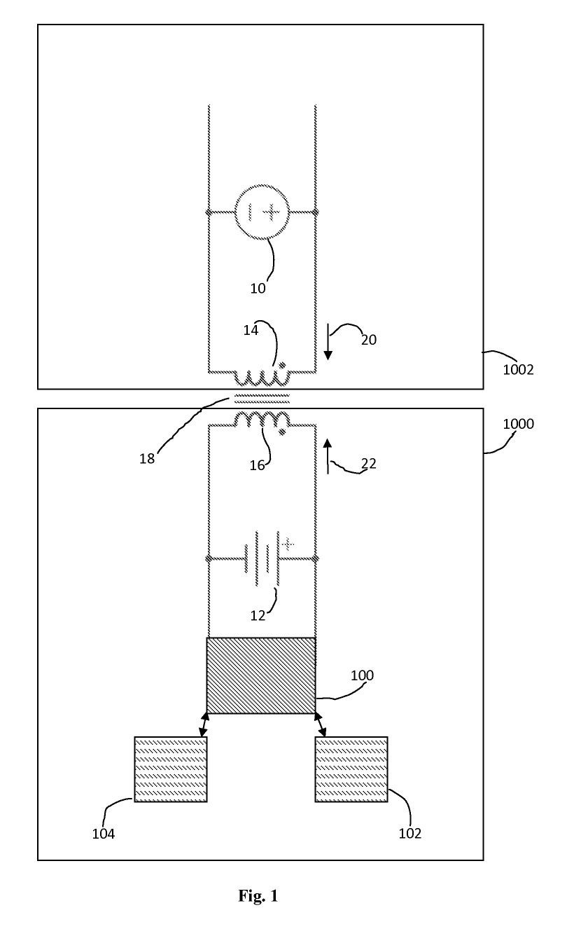

Referring to FIG. 1, a circuit schematic of an embodiment of the invention is provided. Components of the embodiment are contained in separate units, instrumented sensor subsystem (“ISS”) 1000 and coil assembly 1002. ISS 1000 includes one or more internal power storage unit units 12 electrically connected to a sensor 100. In addition, inductive coil 16 may be wired to sensor 100 in parallel with power supply 12.

Coil assembly 1002 includes one or more corresponding external power supply units 10 which deliver current to external inductive coil 14. These components allow inductive coil assembly 1002 to operate independently from the components within ISS 1000.

Coil assembly 1002 is preferably designed to enable physical alignment between external inductive coil 14 of coil assembly 1002 and internal inductive coil 16 of ISS 1000. When external power supply 10 generates an external current 20 through external inductive coil 14 while external inductive coil 14 is aligned with internal inductive coil 16, internal current 22 is generated from magnetic flux delivered across a magnetic flux region 18. Region 18 is defined by the physical space between external inductive coil 14 and internal inductive coil 16. The presence of foreign materials in the magnetic flux region 18 may cause the magnetic flux region to be less effective.

Internal current 22 may serve at least two functions when generated by induction from external inductive coil 14. The internal current 22 may serve as an independent power supply for operating sensor 100, electronics, data storage, or telemetry systems of ISS 1000. Alternatively, this method provides a simple method for recharging power supply 12 of ISS 1000, permitting continuous operation of sensor 100, electronics, data storage, or telemetry systems.

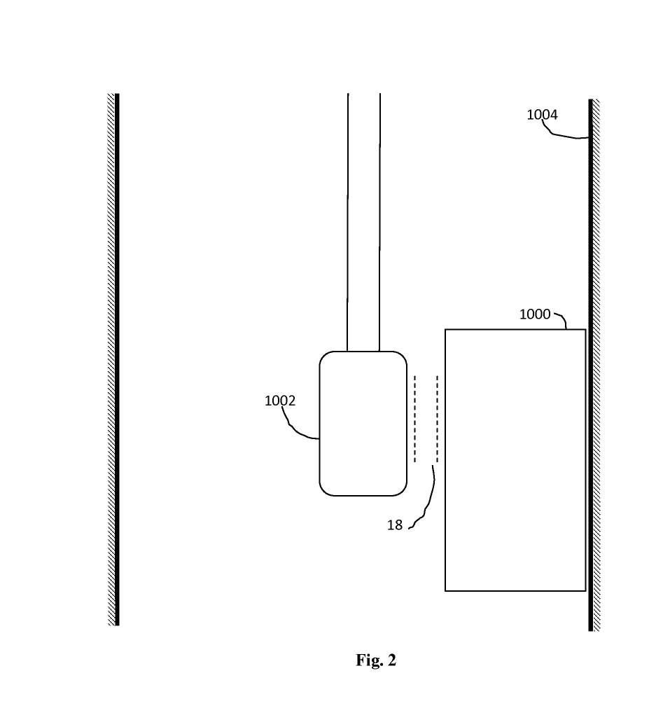

Turning to FIG. 2, a third use for internal current 22 is becomes available when ISS 1000 is connected to or includes a data storage device 102 or data transmission device 104. Internal current 22 may communicate electrical signals to data storage device 102 for later retrieval. Similarly, internal current 22 is capable of communicating electrical signals to data transmission device 104. Data transmission device 104 may be hard-wired to an external instrument or have the ability to communicate data through alternate methods, such as wireless RF modules (not shown).

FIG. 3 illustrates how the use of ISS 1000 and inductive coil assembly 1002 provide advantages when used or installed in equipment 1004. The advantages of a combination power source of conductive coils 14, 16 and internal power storage unit 12 include a non-invasive method for recharging power supply 12 of ISS 1000. Coil assembly 1002 is inserted into equipment 1004 and aligned with ISS 1000. Through inducing current 22 in ISS 1000, power supply 12 is recharged without requiring removal of ISS 1000 from equipment 1004. This method for recharging power supply 12 may be used whether or not ISS 1000 is currently in operation.

The presence of power supply 12 creates a corresponding advantage not seen in the use of conductive coils 14 and 16 alone. The presence of region 18 creates a risk of noise or interruption when the size of region 18 changes or when foreign material enters the magnetic flux region 18. This interruption may reduce the ability of sensor 100 to record accurate measurements. When power supply 12 is available and charged, however, this second power supply ensures that power is continuously provided to sensor 100 during its operation.

Yet another advantage offered by the use of a combination power source in ISS 1000 is the ability to design ISS 1000 with superior design dimensions. For example, the presence of a secondary power source in inductive coil 16 allows for power supply 12 to take the form of a smaller internal power supply, allowing ISS 1000 to have a smaller outer diameter than a comparable unit using only an internal power supply. An ISS 1000 with smaller dimensions and volume is easier to insert or install within equipment 1004.

Although the preferred embodiments of the present invention have been described herein, the above description is merely illustrative. Further modification of the invention herein disclosed will occur to those skilled in the respective arts and all such modifications are deemed to be within the scope of the invention as described by the appended claims.

1. An instrumented sensor subsystem power supply for use in hydrocarbon drilling operations comprising:
an external power supply unit;
an external inductive coil electrically connected to said external power supply unit;
an oilfield component adapted for use in a wellbore;
an instrumented sensor subsystem disposed on said oilfield component, and comprising an internal inductive coil and an internal power storage unit and;
at least one sensor connected to at least one of said internal power storage unit and said internal inductive coil.

2. The instrumented sensor subsystem power supply of claim 1 further comprising at least one signal processing unit connected to at least one of said internal power storage unit and said internal conductive coil.

3. The instrumented sensor subsystem power supply of claim 2 further comprising a data storage device connected to said instrumented sensor subsystem.

4. The instrumented sensor subsystem power supply of claim 2 further comprising a data transmission device connected to said instrumented sensor subsystem.

5. The instrumented sensor subsystem power supply of claim 4 wherein said data transmission device includes an RF module which communicates with said instrumented sensor subsystem by telemetry.

6. A method for powering an instrumented sensor subsystem comprising:
a) providing an oilfield component adapted for use in a wellbore;
b) providing an instrumented sensor subsystem having an internal power storage unit and an internal conductive coil;
c) placing an external inductive coil in proximity to said instrumented sensor subsystem;
d) running an electric current through said external inductive coil to induce an electric current in said internal conductive coil;
e) charging said internal power storage unit of said instrumented sensor subsystem with one of said internal electric current and said internal power storage unit.

7. The method of claim 6 further comprising the additional step of communicating a signal from one of said internal power supply unit and said internal conductive coil to said instrumented sensor subsystem.

8. The method of claim 6 further comprising the steps of connecting a data storage unit to said instrumented sensor subsystem and transmitting data from said instrumented sensor subsystem to said data storage device.

9. The method of claim 6 further comprising the steps of connecting a data transmission unit to said instrumented sensor subsystem and transmitting data from said instrumented sensor subsystem to said data transmission unit.

10. The method of claim 9 wherein said data transmission device further comprises an RF module, which communicates with said instrumented sensor subsystem by wireless RF telemetry.
